(19) United States
(12) Patent Application Publication
(10) Pub. No.: US 2003/0025674 A1
(43) Pub. Date: Feb. 6, 2003

(54) Keyboard device and charging device for portable electronic device

(76) Inventor: Kazutoshi Watanabe, Fukushima-ken (JP)

Correspondence Address: BRINKS HOFER GILSON & LIONE, P.O. BOX 10395, CHICAGO, IL, 60611, US

(21) Appl. No.: 10/165,670

(22) Filed: Jun. 7, 2002

(30) Foreign Application Priority Data
Jun. 8, 2001 (JP) 2001-174494

(51) Int. Cl. G09G 5/00

(52) U.S. Cl. 345/168

(57) ABSTRACT

A keyboard device for a portable electronic device includes a keyboard body having a plurality of key switches arranged on its upper surface, a connecting member to connect the keyboard body to a portable electronic device, and a power supply to one of drive and charge the portable electronic device. The keyboard body, the connecting member, and the power supply are held together inside a housing.

### BACKGROUND OF THE INVENTION

1. Field of the Invention

The present invention relates to a keyboard device and a charging device for a portable electronic device.

2. Description of the Related Art

With recent popularization, portable electronic devices, such as portable information terminals and portable telephones, have advanced functionality. An increasing number of portable electronic devices have an e-mail function and an internet access function. For this reason, character input operations are frequently performed with such small portable electronic devices.

When inputting characters only with these portable electronic devices, in most cases, buttons of a portable telephone are used in combination, handwriting is done on a display screen having a touch pad using a stylus pen, or a keyboard displayed on the display screen is used. None of the above methods enable a comfortable character input.

In order to overcome the above problem, keyboard devices that can be connected to a portable electronic device have been provided. In the keyboard devices, a keyboard body having a plurality of key switches is provided with a guide section to connect a portable electronic device. Some of the keyboard devices have a folding keyboard body. By connecting such a keyboard device to the portable electronic device, character input substantially equivalent to that in electronic devices having a keyboard, such as personal computers, is achieved. This greatly enhances the ease of operation of the portable electronic devices.

In the above existing keyboard devices, however, since the power for driving the keyboard devices depends on a power supply of the portable electronic device, a heavy load is imposed on the power supply of the portable electronic device, and the driving period is shortened. Further, while the portable electronic device is ordinarily used with a charged secondary battery, charging cannot be performed during the operation of the keyboard device because a power terminal is connected to the keyboard device when the portable electronic device is connected to the keyboard device. Conversely, the keyboard device cannot be used during charging.

A folding keyboard device has also been recently provided. While such a keyboard device is easy to carry, it must be opened and held in a flat position during character input operation. However, since a mechanism of the folding keyboard device for maintaining the flat position is not strong enough, for example, when the keyboard device is placed on the lap, it is prone to be bent and to be unstable. Consequently, the keyboard device is unsatisfactory in practicality.

### SUMMARY OF THE INVENTION

The present invention has been made to overcome the above problems, and an object of the invention is to provide a keyboard device for a portable electronic device which allows character input without shortening the battery charge duration, and which can be operated while charging the portable electronic device connected thereto.

Another object of the present invention is to provide a charging device for a portable electronic device which has an input device capable of being operated while charging the portable electronic device.

In order to achieve the above objects, according to an aspect, the present invention provides a keyboard device for a portable electronic device including a keyboard body having a plurality of key switches arranged on the upper surface thereof, a connecting mechanism to connect the keyboard body and a portable electronic device, and a power supply to one of drive and charge the portable electronic device, the keyboard body, the connecting mechanism, and the power supply being placed together inside a housing.

In the present invention, the portable electronic device refers to a small electronic device that is portable, for example, a portable information terminal and a portable telephone. Since the keyboard device of the present invention has a structure in which the keyboard body assists character input to the portable electronic device, the connecting mechanism to the portable electronic device, and the power supply are placed together inside the housing, characters can be comfortably input from the keyboard body to the portable electronic device by connecting the portable electronic device to the keyboard device.

Since the keyboard device of the present invention has the power supply, character input is possible without depending on the power supply of the portable electronic device. Further, when the power supply has a charging function, the portable electronic device can be operated while being charged. Therefore, the keyboard device of the present invention can overcome the above conventional problems, and can substantially enhance the ease of operation of the portable electronic device.

The keyboard device may have an interface for connection to an external electronic device such as a personal computer. This allows data to be exchanged with the external electronic device via the keyboard device. In a state in which the keyboard device is connected to the external electronic device, the user can establish a connection to the external electronic device only by connecting the portable electronic device to the keyboard device. Consequently, quick data exchange is possible.

According to another aspect, the present invention provides a keyboard device for a portable electronic device including a keyboard body having a plurality of key switches arranged on the upper surface thereof, a connecting mechanism to connect the keyboard body and a portable electronic device, and a connecting portion to connect a power supply to one of drive and charge the portable electronic device, the keyboard body, the connecting mechanism, and the connecting portion being placed together inside a housing.

Preferably, the power supply is a secondary battery. In this case, both the portable electronic device and the keyboard device can be used without using an external power supply, and therefore, portability of the keyboard device can be enhanced.

The power supply may be connected to an external power supply. In this case, the keyboard device can be operated without depending on the power supply of the portable electronic device. Moreover, the portable electronic device can be operated while being charged by the external power supply. Further, when the keyboard device has a secondary battery, since the secondary battery can be charged in this configuration, characters can be input from the keyboard device to the portable electronic device while charging the portable electronic device and the keyboard device in an environment where the keyboard device can be connected to an external power supply.

Preferably, the connecting mechanism has a cradle section for holding the portable electronic device, and the cradle section can tilt relative to the housing.

That is, since the cradle section disposed in the keyboard device can tilt relative to the housing in a state in which the portable electronic device is connected to the cradle section, for example, when the cradle section is placed on the rear side of the keyboard body, the portable electronic device can be placed in an upright position on the rear side of the keyboard body, and the tilting angle can be freely adjusted. Since this adjusting function allows the angle of a display section of the portable electronic device to be adjusted in accordance with the line of sight of the user, character input to the portable electronic device is made more comfortable, and the ease of operation is substantially enhanced.

Preferably, a connecting portion between the cradle section and the housing has a ratchet mechanism In this case, the cradle section can tilt relative to the housing with a simple structure, and can be fixed at an arbitrary tilting angle. Consequently, it is possible to easily achieve an easy-to-use keyboard device at a low cost.

Preferably, the connecting mechanism has a connector for electrically connecting the portable electronic device and the keyboard device. In this case, communication between the portable electronic device and the keyboard device can be made possible by connecting the connector to a connector of the portable electronic device for external connection, and the power to one of drive and charge the portable electronic device can be supplied to the portable electronic device via the connector.

Preferably, the connecting mechanism has a wireless communicator (transmitter/receiver) that permits communication between the portable electronic device and the keyboard device. In this case, since a connection can be established between the portable electronic device and the keyboard device by the wireless communicator, operations, such as character input to the portable electronic device, can be performed using the keyboard device without connecting the portable electronic device and the keyboard device via a connector or a cable.

In the present invention, the wireless communicator refers to a communicator that allows information to be transmitted and received among a plurality of electronic devices using infrared rays, electric waves, or the like. Examples of the wireless communicator are a communication method using IrDA (Infrared Data Association) that conducts communication with infrared rays, and a communication method using radio waves.

Preferably, the housing has at least one speaker. In this case, when the portable electronic device has a function of playing back voice and music, the voice and music can be played back through the speaker of high tone quality. The user need not wear headphones or an earphone, and can comfortably perform operations such as character input. The speaker may be placed at any position in the housing.

Preferably, the speaker can tilt relative to the keyboard body or the housing. In this case, the flexibility in placement of the speaker is increased, and the ease of operation of the keyboard device is further enhanced.

Preferably, the keyboard device for a portable electronic device of the present invention may have an opening and closing protective cover connected to the housing.

Since the keyboard body, the speaker, the connecting portion, and the like held in the housing can be protected by the opening and closing protective cover, the portability of the keyboard device can be further enhanced.

Preferably, the protective cover has a pivotal connecting plate at its base end, and the connecting plate is pivotally connected to the housing, and is placed at one side face of the housing in a state in which the protective cover is closed.

That is, the connecting plate has a length substantially equal to the thickness of the housing, and is connected to the lower rear side of the housing. The protective cover is connected to the connecting plate so as to cover the upper surface of the housing. Therefore, the protective cover and the connecting plate can pivot relative to the housing. Since the protective cover having such a structure can be moved under the housing when opened, it does not interfere with the use of the keyboard device, and the ease of operation of the keyboard device can be enhanced.

Preferably, when the protective cover is opened, it is placed under the housing, the housing is supported by the connecting plate, and at least a part of the housing is inclined with respect to the protective cover.

That is, the protective cover is placed under the housing in an open state. The connecting plate stands from the base end of the protective cover, and the housing connected to the connecting plate is thereby separated from the protective cover.

In this case, the protective cover can be placed under the housing so that it will not interfere with the use of the keyboard device. When the keyboard body disposed in the housing is fixed while being inclined with respect to the protective cover, character input is made more comfortable. Alternatively, when the housing has a speaker and the speaker can tilt relative to the keyboard body, the keyboard body is placed in parallel with the protective cover, and only the speaker is tilted by supporting and tilting a portion with the speaker by the connecting plate.

That is, in this case, the keyboard body can be inclined with respect to the protective cover, and can also be placed in parallel therewith. Therefore, the user can select the position at which the keyboard body can be used more easily, and the ease of operation of the keyboard device is enhanced.

Preferably, the protective cover can fold at a center folding portion, and one side of the protective cover parallel to the folding portion is connected to the front side of the housing so that the protective cover can open and close.

In this case, the protective cover is opened, is folded into two, and is placed on the front side of the housing. In this state, the protective cover can be used as a palm rest. Therefore, the user can more comfortably input characters using the keyboard device.

Preferably, the keyboard body is held in the housing so as to move into and out of the housing, and the connecting mechanism is disposed on the upper surface of the housing.

That is, the keyboard device having this configuration is used in a state in which a portable electronic device is connected to the connecting mechanism disposed on the upper surface of the housing, and the keyboard body is drawn out from the housing during operation. Since the keyboard body is stored in the housing in this configuration, it can be protected when carried. Moreover, since the connecting mechanism is disposed on the upper surface of the housing, the size of the keyboard device in the plane direction can be made less than that in a case in which the connecting mechanism is disposed at the rear of or by the side of the keyboard body. This increases the portability. A speaker may be disposed together with the connecting mechanism on the upper surface of the housing, and may tilt relative to the housing.

Preferably, the keyboard body has an auxiliary storage that can exchange data with the portable electronic device.

Since the auxiliary storage can be used for data backup of the portable electronic device, and can be used as another storage, even when data stored in the portable electronic device is lost or damaged, it can be restored safely. When an application or the like is stored in the auxiliary storage and is transferred to the portable electronic device, as necessary, the limited storage capacity of the portable electronic device can be used effectively. When the keyboard device has a speaker, music and voice stored in the auxiliary storage can be played back with just the keyboard device without being connected to the portable electronic device by adding a function of outputting the music and voice from the speaker.

While the auxiliary storage of the keyboard device may be any type of information storage device, such as a nonvolatile memory or a hard disk, a nonvolatile memory is preferable from the viewpoint of weight and size reduction of the keyboard device.

Preferably, the housing has a voice input mechanism. In this case, for example, when a portable telephone is connected to the keyboard device, talking on the portable telephone (hands-free conversation) is possible while operating the keyboard device. Even when a voice memo function of a portable information terminal or the like is used, a voice memo can be recorded while operating the keyboard device. Therefore, the ease of operation of the portable electronic device can be further enhanced.

According to a further aspect, the present invention provides a charging device for a portable electronic device including a connecting mechanism for electrically connecting the charging device and a portable electronic device, a power supply to one of drive and charge the portable electronic device, and an input to operate the portable electronic device in a state in which the portable electronic device is connected to the charging device, the connecting mechanism, the power supply, and the input mechanism being stored together inside a housing.

The input mechanism in the charging device for a portable electronic device refers to an input mechanism for portable electronic devices, for example, keyboard devices, coordinate input devices, and voice input devices. By adopting the above configuration, the portable electronic device can be operated with the input mechanism while being charged.

Further objects, features and advantages of the present invention will become apparent from the following description of the preferred embodiments with reference to the attached drawings.

### BRIEF DESCRIPTION OF THE DRAWINGS

FIG. 1 is a perspective view of a keyboard device for a portable electronic device according to a first embodiment of the present invention;

FIG. 2 is a perspective view showing a state in which a protective cover of the keyboard device shown in FIG. 1 is closed;

FIGS. 3A, 3B, and 3C are partial side views of the keyboard device shown in FIG. 1;

FIG. 4 is an enlarged perspective structural view of a cradle section in the keyboard device shown in FIG. 1;

FIGS. 5A and 5B are schematic perspective views of a keyboard device according to a second embodiment of the present invention, respectively, showing a state in which a keyboard body is stored in a housing and a state in which the keyboard body is drawn out of the housing;

FIG. 6 is a schematic perspective view showing an example in which a portable telephone is connected to the keyboard device of the second embodiment;

FIGS. 7A and 7B are schematic perspective views of a keyboard device according to a third embodiment of the present invention, respectively, showing a state in which a protective cover is closed and a state in which the protective cover is open; and

FIG. 8 is a schematic perspective view showing an example in which a portable telephone is connected to the keyboard device of the third embodiment.

### DESCRIPTION OF THE PREFERRED EMBODIMENTS

While embodiments of the present invention will be described below with reference to the attached drawings, the present invention is not limited to the following embodiments.

[First Embodiment]

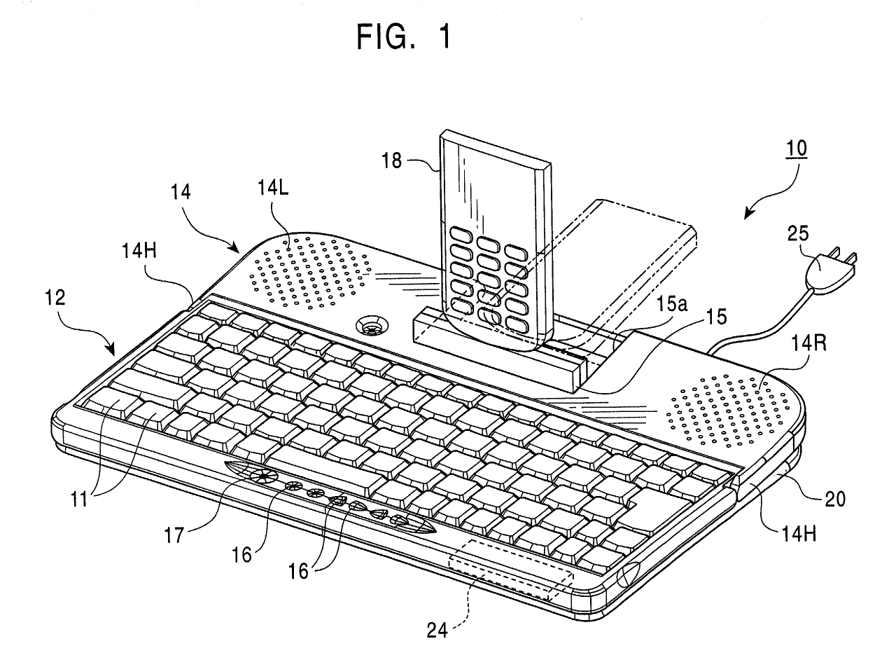

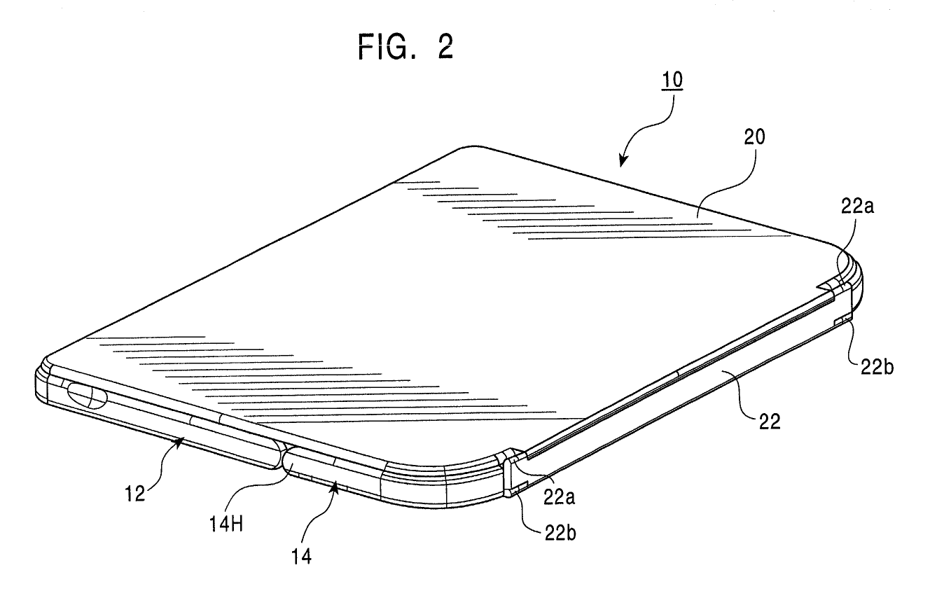

FIG. 1 is a perspective structural view schematically showing a keyboard device according to a first embodiment of the present invention, and FIG. 2 is a perspective view showing a state in which a protective cover formed in the keyboard device shown in FIG. 1 is closed.

Referring to FIG. 1, in a keyboard device 10 of the first embodiment, a flat keyboard body 12 having a plurality of key switches 11 arranged thereon, and a flat speaker section 14 connected to the rear side of the keyboard body 12 are combined so as to form a housing, and a cradle section (connecting mechanism) 15 is disposed on the front side of a recess 15a formed in the center of the speaker section 14. Both rear ends of the keyboard body 12 and both front ends of the speaker section 14 are connected by hinge portions 14H so that the speaker section 14 tilts relative to the keyboard body 12. In the keyboard device 10 shown in FIG. 1, a portable information terminal 18 is supported at the leading end of the cradle section 15 via a connector (not shown) disposed thereat, and is electrically connected to the keyboard device 10.

As shown in FIG. 2, the keyboard device 10 of this embodiment has a protective cover (covering member) 20 having a size large enough to cover the upper surfaces of the keyboard body 12 and the speaker section 14. One side of a connecting plate 22 having a width corresponding to the thickness of the speaker section 14 and a length slightly less than that of the speaker section 14 is pivotally connected to a base side (rear end) of the protective cover 20 via hinge portions 22a. The other side of the connecting plate 22 opposite from the protective cover 20 is pivotally connected to the rear bottom end side of the speaker section 14 via hinge portions 22b. That is, the protective cover 20 and the connecting plate 22 can pivot relative to the speaker section 14. Therefore, while the keyboard device 10 is not used, the protective cover 20 is placed on the upper surfaces of the keyboard body 12 and the speaker section 14 so as to protect the keyboard body 12 and the speaker section 14, as shown in FIG. 2. In a state in which the protective cover 20 is closed, the connecting plate 22 is placed along the rear side face of the speaker section 14. For this reason, various connectors disposed on the rear side face of the speaker section 14 are covered with the connecting plate 22 and are protected from fracture only by closing the protective cover 20.

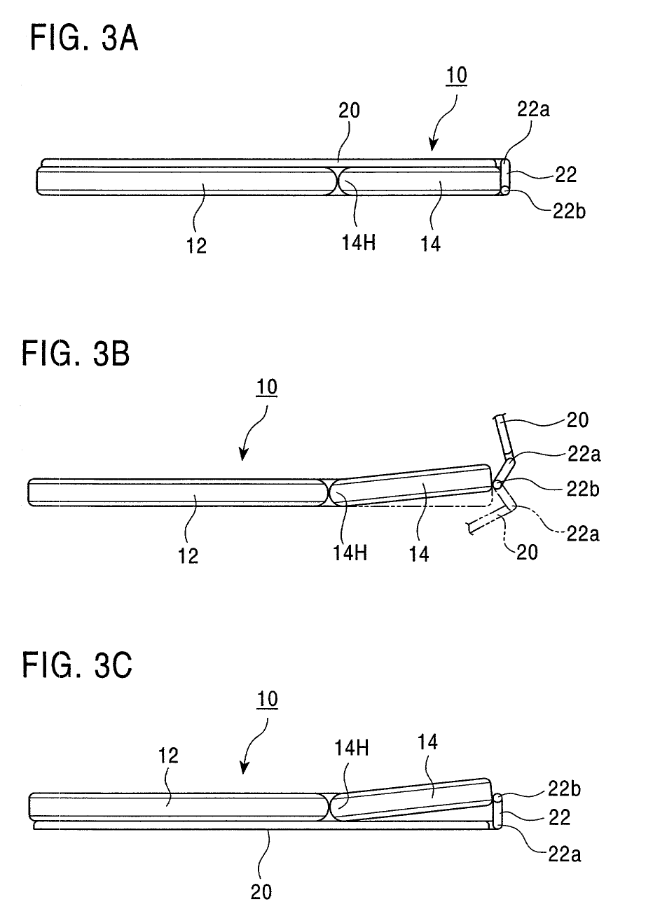

Opening of the protective cover 20 will now be described with reference to FIGS. 1 and 3A to 3C. FIG. 3A is a side view showing a state in which the protective cover 20 of the keyboard device 10 is closed, FIG. 3B is a side view showing a state in which the protective cover 20 is being pivoted, and FIG. 3C is a side view showing a state in which the protective cover 20 is opened and is placed under the keyboard body 12.

When the protective cover 20 is opened, it is pivoted upward about the hinge portions 22a and is brought into a state shown in FIG. 3B. Next, the protective cover 20 and the connecting plate 22 are pivoted toward the lower side of the keyboard body 12, as shown in FIG. 3B, and are brought into a state shown in FIG. 3C. In the state shown in FIG. 3C, the protective cover 20 and the connecting plate 22 are fixed at the position where the leading end of the protective cover 20 and the front lower end of the keyboard body 12 are substantially aligned. When the protective cover 20 is moved to that position, the connecting plate 22 connected to the base end of the protective cover 20 is placed between the base end of the protective cover 20 and the rear lower end of the speaker section 14, as shown in FIG. 3C. By tilting the speaker section 14 in this state, as shown in FIG. 3C, the protective cover 20 is placed under the keyboard body 12, and the speaker section 14 is inclined with respect to the keyboard body 12, and is supported by the connecting plate 22 at a distance from the base end of the protective cover 20.

When the parts of the keyboard device 10 are thus placed in the state in which the protective cover 20 is opened, the speaker section 14 slightly faces toward the operator, and the portable information terminal 18 connected to the cradle section 15 at the center of the speaker section 14 is also placed so as to slightly face the operator without raising the cradle section 15. By adjusting the tilting angle of the cradle section 15, as necessary, the portable information terminal 18 and a display thereof can be placed at a position where they can be more easily operated by the operator.

While the speaker section 14 tilts relative to the keyboard body 12 in FIGS. 1 and 3A to 3C, the keyboard device 10 can be used without tilting the speaker section 14. That is, the protective cover 20 is moved to the lower side of the keyboard device 10 while the speaker section 14 and the keyboard body 12 are placed in horizontal position, and is fixed in a state in which the leading end thereof is substantially aligned with the front end of the rear surface of the keyboard body 12. In this arrangement, the back surfaces of the keyboard body 12 and the speaker section 14 are separated from the front surface of the protective cover 20 by the connecting plate 22. That is, the upper surfaces of the key switches 11 in the keyboard body 12 are inclined with respect to the protective cover 20. In such an arrangement and the above arrangement in which the speaker section 14 is tilted, the portable information terminal 18 can be placed at an easy-to-use position by controlling the tilting angle of the cradle section 15 in the keyboard device 10 of this embodiment. This enhances the ease of operation.

In FIG. 1, the keyboard body 12 is of a full-size type, and has a plurality of control buttons 16 and a microphone (voice input mechanism) 17 disposed on the center of the front upper face on which the key switches 11 are arranged. These control buttons 16 are used to serve a music playback function of the portable information terminal 18. The microphone 17 is used to serve a function that requires voice input, for example, a voice memo function of the portable information terminal 18.

The control buttons 16 may be provided not only for the music playback function of the portable information terminal 18, but also for other functions. For example, in a case in which keyboard device 10 has a printing function for printing the output from the portable information terminal 18, or in a case in which the portable information terminal 18 has a camera, the control buttons 16 may be assigned to these functions. The control buttons 16 can serve the functions of both the portable information terminal 18 and the keyboard device 10. It may be determined, depending on the usage and situation, for which of the portable information terminal 18 and the keyboard device 10 the control buttons 16 are operated.

The keyboard layout of the keyboard device 10 of the present invention is not limited. The pitch and stroke of the key switches 11 may be appropriately determined in accordance with the size of the keyboard device 10.

Circular speakers 14L and 14R are disposed on both ends of the upper surface of the speaker section 14 in the keyboard device 10 so as to enable stereophonic playback of music and voice. Because of such a configuration, when a portable telephone is mounted in the cradle section 15, hands-free conversation can be performed with the microphone 17 and the speakers 14L and 14R.

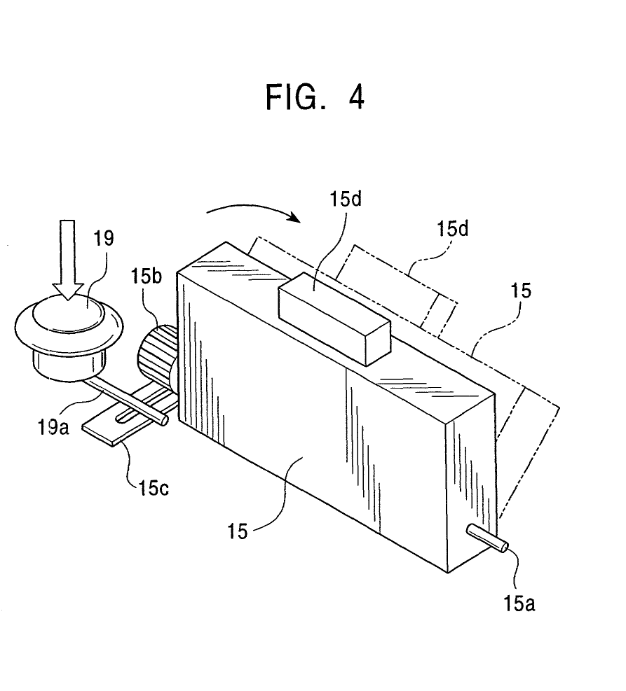

The cradle section 15 is disposed on the upper center of the speaker section 14, to which a portable information terminal and a portable telephone are connected. The cradle section 15 can tilt relative to the speaker section 14. In the keyboard device 10 of this embodiment, the tilting angle of the cradle section 15 can be freely adjusted by a ratchet mechanism. FIG. 4 is an enlarged perspective structural view of the cradle section 15. As shown in the figure, rotating shafts 15a for tilting the cradle section 15 relative to the speaker section 14 are disposed on both lower sides of the cradle section 15. A gear portion 15b is formed on the left shaft 15a in the figure, and is meshed with the leading end of a leaf spring 15c. A connector 15d for electrically connecting the portable information terminal 18 and the keyboard device 10 is disposed on the upper side of the cradle section 15. A rod-like connecting member 19a extends from the bottom of a release button 19 disposed on the left side of the cradle section 15 to the upper surface of the leaf spring 15c.

In a normal state, the cradle section 15 is urged so that the leading end thereof faces toward the rear side of the speaker section 14. In this state, the upper surface of the cradle section 15 and the upper surface of the speaker section 14 are flush with each other. During operation, the cradle section 15 is pivoted about the base end and is raised at an arbitrary angle. In order to return the raised cradle section 15 to its initial position, the release button 19 disposed on the left side of the cradle section 15 is depressed. By depressing the release button 19, as shown in FIG. 4, the connecting member 19a at the bottom of the release button 19 is pressed down. Consequently, the leaf spring 15c is pressed and bent from the upper side by the connecting member 19a, the leading end thereof meshed with the gear portion 15b separates therefrom, and the cradle section 15 is released and returned into its initial position.

The cradle section 15 may be urged in a raised position. In this case, the cradle section 15 is fixed inside the recess 15a in a non-operation state, and is raised by depressing the release button 19 when used.

While the portable information terminal 18 is supported by the connector disposed at the leading end of the cradle section 15 in the keyboard device 10 of the present invention, the cradle section 15 may be provided with a guide portion which conforms to the shape of the portable information terminal 18. That is, the portable information terminal 18 may be inserted from the leading end of the cradle section 15 along the guide section, and may be connected to a connector disposed at the inner bottom of the cradle section 15. Since such a structure allows the guide portion to support the portable information terminal 18, an excessive load is not imposed on the connector, and the connector is prevented from being damaged.

As shown in FIG. 1, a secondary battery (power supply) 24 for driving the keyboard device 10 is built in the keyboard body 12 (inside the right front portion in FIG. 1), so that the keyboard device 10 can operate without depending on a power supply of the portable information terminal 18 connected to the cradle section 15. In the keyboard device 10 of this embodiment, a power cord 25 connected to the rear side face of the speaker section 14 can be connected to an external power supply. It is preferable that the power cord 25 have a connector at its base end, and that the connector be detachable to a terminal formed in a part of the housing. Since the keyboard device 10 is driven by the secondary battery 24 built in the keyboard body 12 in such a power-supply configuration, load is prevented from being imposed on the power supply of the portable information terminal 18. The secondary battery 24 of the keyboard device 10 and the power supply (battery) of the portable information terminal 18 can be charged by connecting the keyboard device 10 to an external power supply via the power cord 25.

In the keyboard device 10 of this embodiment having the above configuration, characters can be comfortably input from the keyboard body 12 to the portable information terminal 18, and the portable information terminal 18 can be easily placed in an easy-to-use position because the cradle section 15 can tilt. During operation, since the keyboard body 12 or the speaker section 14 can be placed at an angle to the protective cover 20 disposed on the rear side of the keyboard body 12, ease of operation is enhanced.

Further, since the keyboard device 10 has the secondary battery therein, it can operate without sharing the power supply of the portable information terminal 18. Moreover, the portable information terminal 18 can be charged because the keyboard device 10 can be connected to an external power supply. By using the secondary battery and the external power supply in combination, the portable information terminal 18 can be operated while being charged.

By using the microphone 17 and the speakers 14L and 14R in combination, hands-free conversation and recording/playback of a voice memo can be performed when a portable telephone is connected to the keyboard device 10. Since the control buttons 16 for the music playback function are disposed on the upper front side of the keyboard body 12, music can be output from the speakers 14L and 14R by operating the control buttons 16. When the keyboard device 10 has a memory, such as a nonvolatile memory or a hard disk, in which music and voice are recorded, music and voice can be played back and can be output from the speakers 14L and 14R with just the keyboard device 10 by operating the control buttons 16.

[Second Embodiment]

A second embodiment of the present invention will be described in detail below with reference to the drawings.

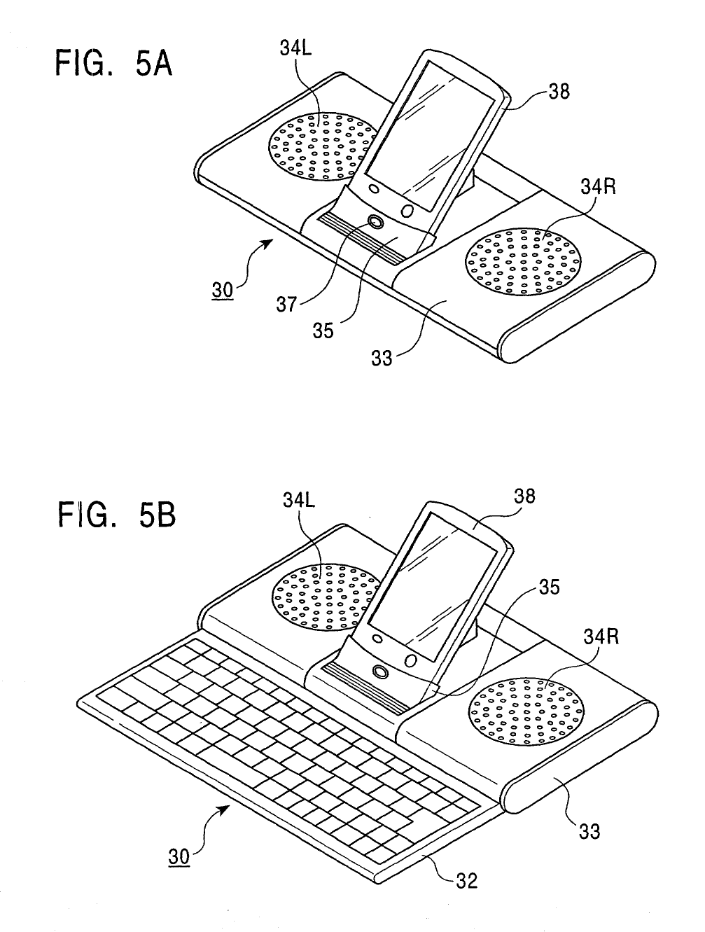

FIGS. 5A and 5B are perspective structural views of a keyboard device according to a second embodiment of the present invention. FIG. 5A shows a state in which a keyboard body 32 is stored inside a housing 33, and FIG. 5B shows a state in which the keyboard body 32 is drawn out of the housing 33. A keyboard device 30 shown in these figures generally comprises the housing 33, the retractable keyboard body 32 so as to move into and out of the housing 33 through the front side face, speakers 34L and 34R disposed on both upper ends of the housing 33, and a cradle section (connecting mechanism) 35 disposed at the upper center of the housing 33. A portable information terminal 38 is inserted from the leading end into the base end of the cradle section 35, and is electrically connected to the keyboard device 30 by a connector (not shown).

The cradle section 35 can tilt relative to the housing 33, in a manner similar to that of the cradle section 15 shown in FIG. 1. The portable information terminal 38 can be placed in an easy-to-use position by controlling the tilting angle of the cradle section 35. The raised cradle section 35 is returned into its initial position by depressing a release button 37 formed on the upper center of the cradle section 35.

The speakers 34L and 34R disposed at both upper ends of the housing 33 can output music and voice played back by the portable information terminal 38, in a manner similar to that in the keyboard device 10 of the above first embodiment. When the keyboard device 30 has a music playback function, music can be played back with just the keyboard device 30. While the speakers 34L and 34R are fixed to the upper surface of the housing 33 in FIGS. 5A and 5B, they may tilt relative to the housing 33. In such a structure, since the tilting angle of the speakers 34L and 34R can be freely adjusted, the user can place the speakers 34L and 34R in the position where the user can comfortably listen to music and voice. This increases the ease of operation of the keyboard device 30.

Although not shown, the keyboard device 30 of this embodiment has a secondary battery built therein, and can be connected to an external power supply. Since the keyboard device 30 is driven by the built-in secondary battery, it can be operated without minding the remaining charge of a battery of the portable information terminal 38, and can be operated while charging the portable information terminal 38.

The major characteristic of the keyboard device 30 is in that the keyboard body 32 is stored inside the housing 33 when not used, and is drawn out as necessary, as shown in FIG. 5B. This structure makes it possible to make the planar size of the housing less than that in the keyboard device 10 shown in FIG. 1, to reduce the footprint on the desk, and to effectively use the space on the desk.

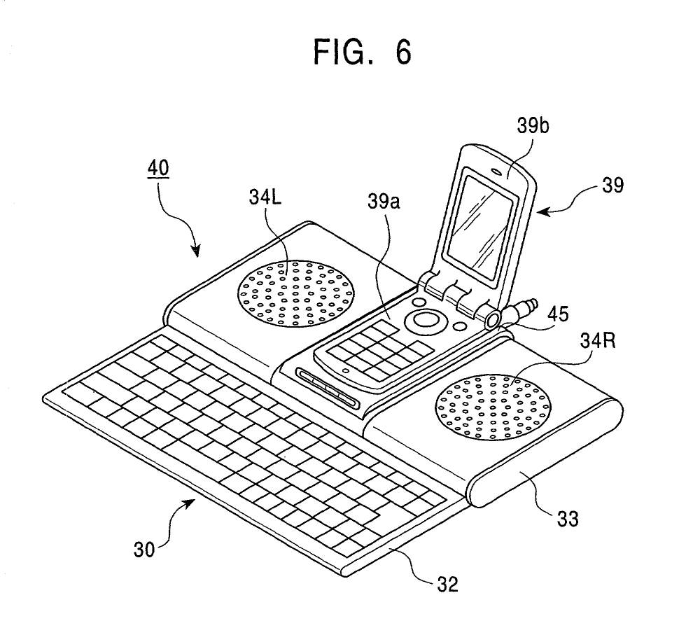

The keyboard device 30 of this embodiment can be used not only for the portable information terminal, but also for a portable telephone. FIG. 6 is a perspective structural view of a keyboard device 40 that can be connected to a portable telephone 39, as a modification of the keyboard device 30 of the second embodiment. The keyboard device 40 has functions equivalent to those of the keyboard device 30 shown in FIGS. 5A and 5B except in the shape of a cradle section 45 serving as a connecting portion to the portable telephone 39. Therefore, the cradle section 45 will be described in detail below. In FIG. 6, the same components as those in FIG. 5B are denoted by the same numerals, and detailed descriptions thereof are omitted.

In the keyboard device 40 shown in FIG. 6, an operating section 39a of a folding portable telephone 39 having control buttons and the like, to which a display section 39b having a liquid crystal panel or the like is movably connected, is fitted in the cradle section 45. Although not shown, a connector is disposed on the inner side of the cradle section 45 so as to electrically connect the portable telephone 39 fitted in the cradle section 45, and the keyboard device 40.

Since the keyboard device 40 of this embodiment is used in combination with the folding portable telephone 39, it does not have a mechanism for tilting the cradle section 45, and is placed in an easy-to-use position by controlling the tilting angle of the display section 39b of the portable telephone 39.

In the keyboard device 40 of this embodiment having the above configuration, comfortable character input with the keyboard body 32 is also possible. Moreover, hands-free talking on the portable telephone 39 can be performed by using speakers 34L and 34R disposed on the upper surface of the housing 33 in combination with a microphone. The microphone may be built in the keyboard device 40, or in the portable telephone 39.

[Third Embodiment]

A third embodiment of the present invention will be described in detail below with reference to the drawings.

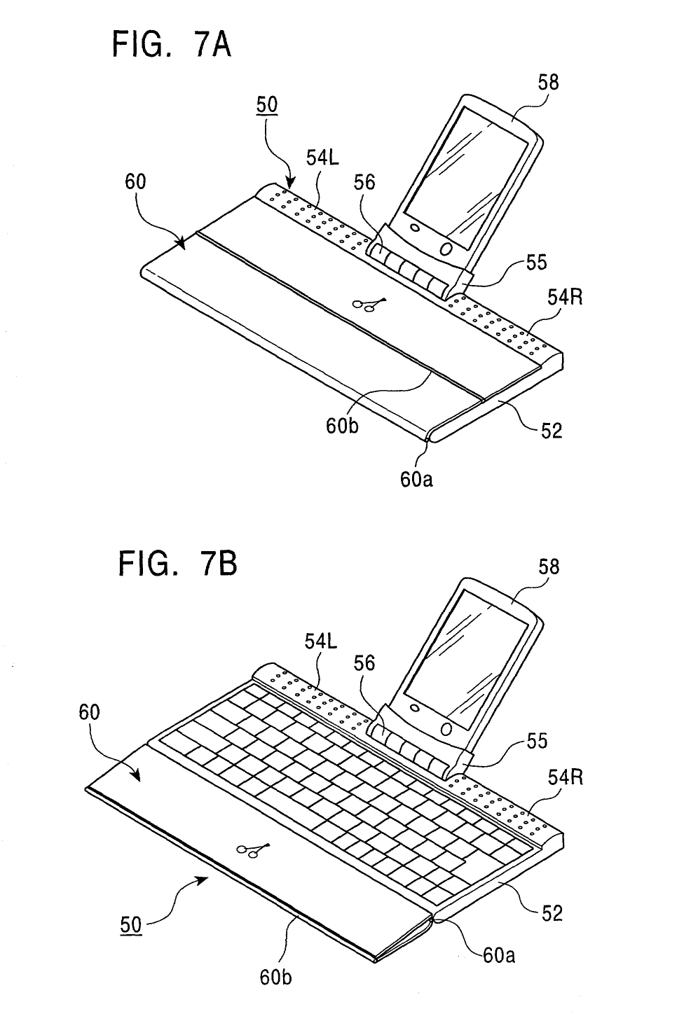

FIGS. 7A and 7B are perspective structural views of a keyboard device 50 according to a third embodiment of the present invention. FIG. 7A shows a state in which a protective cover 60 of the keyboard device 50 is closed, and FIG. 7B shows a state in which the protective cover 60 is open. The keyboard device 50 shown in these figures comprises a keyboard body 52, speakers 54L and 54R disposed at both rear ends of the keyboard body 52, a cradle section 55 disposed at the rear center of the keyboard body 52, and the protective cover 60 connected to the keyboard body 52 via a hinge portion 60a formed on the front side face of the keyboard body 52.

The cradle section 55 at the rear center of the keyboard body 52 is shaped so that a portable information terminal 58 can be inserted and fitted therein. Although not shown, a connector is disposed at the inner bottom of the cradle section 55 so as to electrically connect the portable information terminal 58 and the keyboard device 50. The cradle section 55 tilts at its base end 56 relative to the keyboard body 52. Therefore, the portable information terminal 58 connected via the cradle section 55 can be placed in an easy-to-use position by controlling the tilting angle of the cradle section 55.

The speakers 54L and 54R on both sides of the cradle section 55 in the rear of the keyboard body 52 can output music and voice played back by the portable information terminal 58, in a manner similar to that in the keyboard devices of the above first and second embodiments. Although not shown, the keyboard device 50 of this embodiment also has a secondary battery therein, and can be connected to an external power supply. Since the keyboard device 50 is driven by the built-in secondary battery, operations, such as character input, can be performed without minding the remaining charge of the battery of the portable information terminal 58, and can be performed while charging the portable information terminal 58 by using the external power supply.

The keyboard device 50 of this embodiment is characterized in that the protective cover 60 folds in the longitudinal direction at a folding portion 60b formed of a hinge at the center thereof. That is, as shown in FIG. 7B, when the protective cover 60 is opened, it pivots frontward about the base end 60a, is also folded at the center folding portion 60b, and is placed on the front side of the keyboard body 52. In this state, the leading end of the protective cover 60 is moved on the base end 60a, and is placed at the front side face of the keyboard body 52. The protective cover 60 in such an open state can be also used as a palm rest. That is, the keyboard device 50 allows the portable information terminal 58 to be more comfortably operated because the user can input characters while placing the wrists on the palm rest.

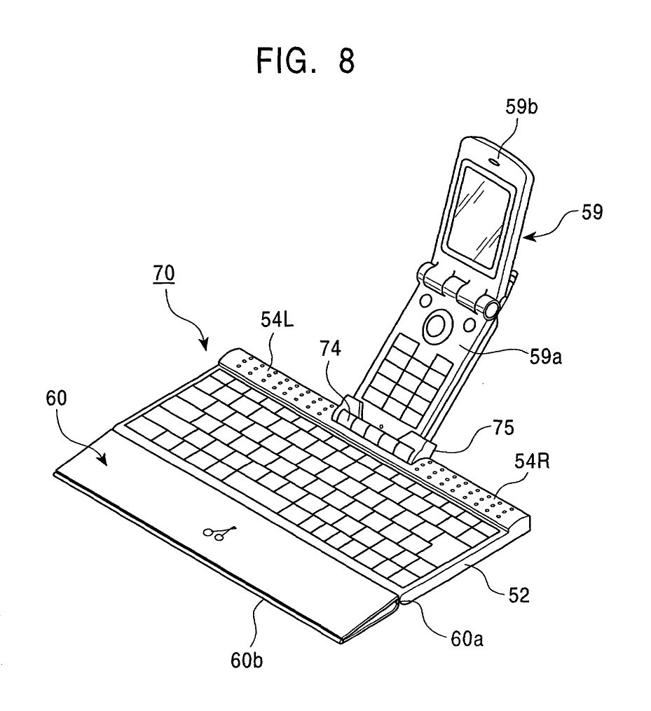

The keyboard device 50 of this embodiment can also be used for a portable telephone, in a manner similar to that in the keyboard device 40 of the above second embodiment. FIG. 8 is a perspective structural view of a keyboard device 70 as an example in which a portable telephone 59 is connected to the keyboard device 50 of the third embodiment. The keyboard device 70 shown in FIG. 8 has functions similar to those of the keyboard device 50 shown in FIGS. 7A and 7B except in the shape of a cradle section 75 serving as a connecting portion to the portable telephone 59. Therefore, a detailed description will be given below of the cradle section 75. In FIG. 8, the same components as those in FIGS. 7A and 7B are denoted by the same reference numerals, and detailed descriptions thereof are omitted.

As shown in FIG. 8, an operating section 59a of a folding portable telephone 59 having control buttons and the like, to which a display section 59b having a liquid crystal panel or the like is movably connected, is fitted in the cradle section 75. Although not shown, a connector is disposed at the inner bottom of the cradle section 75. The connector is connected to the bottom of the operating portion 59a of the portable telephone 59 at the inner bottom of the cradle section 75, thereby electrically connecting the portable telephone 59 and the keyboard device 70.

Since the cradle section 75 can tilt relative to a keyboard body 52 at its base end 74 in the keyboard device 70, the display portion 59b of the portable telephone 59 can be moved to a position such that it can be easily viewed, by controlling the tilting angle of the cradle section 75. When the portable telephone 59 is of a folding type, as shown in FIG. 8, the tilting angle of the display portion 59b may be adjusted.

In the keyboard device 70 of this embodiment having the above configuration, a more comfortable character input with the keyboard body 52 is also possible. Moreover, hands-free talking on the portable telephone 59 can be performed by using speakers 54L and 54R disposed on the upper rear surface of the keyboard body 52 and a microphone in combination. The microphone may be built in the keyboard device 70 or in the portable telephone 59.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A keyboard device for a portable electronic device comprising:
a keyboard body having a plurality of key switches arranged on an upper surface thereof:
connecting mechanism to connect said keyboard body to a portable electronic device; and
a power supply to one of drive and charge said portable electronic device,
wherein said keyboard body, said connecting mechanism, and said power supply are held together inside a housing.

2. A keyboard device for a portable electronic device comprising:
a keyboard body having a plurality of key switches arranged on an upper surface thereof;
a connecting mechanism to connect said keyboard body to a portable electronic device; and
a connecting portion to connect a power supply to one of drive and charge said portable electronic device,
wherein said keyboard body, said connecting mechanism, and said connecting portion are held together inside a housing.

3. A keyboard device for a portable electronic device according to claim 1, wherein said power supply is a secondary battery.

4. A keyboard device for a portable electronic device according to claim 1, wherein said power supply is connectable to an external power supply.

5. A keyboard device for a portable electronic device according to claim 1, wherein said connecting mechanism has a cradle section that holds said portable electronic device, and said cradle section tilts relative to said housing.

6. A keyboard device for a portable electronic device according to claim 5, wherein a connecting portion between said cradle section and said housing has a ratchet mechanism.

7. A keyboard device for a portable electronic device according to claim 1, wherein said connecting mechanism has a connector that electrically connects said portable electronic device and said keyboard device.

8. A keyboard device for a portable electronic device according to claim 1, wherein said connecting mechanism has a wireless communicator that permits communication between said portable electronic device and said keyboard device.

9. A keyboard device for a portable electronic device according to claim 1, wherein said housing has at least one speaker.

10. A keyboard device for a portable electronic device according to claim 9, wherein said speaker tilts relative to one of said keyboard body and said housing.

11. A keyboard device for a portable electronic device according to claim 1, further comprising a protective cover connected to said housing so as to open and close.

12. A keyboard device for a portable electronic device according to claim 11, wherein said protective cover has a pivotal connecting plate at an base end thereof, and said connecting plate is pivotally connected to said housing, and is placed at one side face of said housing in a state in which said protective cover is closed.

13. A keyboard device for a portable electronic device according to claim 12, wherein, when said protective cover is opened, said protective cover is placed under said housing, said housing is supported by said connecting plate, and at least a part of said housing is inclined with respect to said protective cover.

14. A keyboard device for a portable electronic device according to claim 11, wherein said protective cover folds at a center folding portion, and said protective cover is pivotally connected to a front side of said housing at one side thereof parallel to said folding portion.

15. A keyboard device for a portable electronic device according to claim 1, wherein said keyboard body is held in said housing so as to move into and out of said housing, and said connecting mechanism is disposed on the upper surface of said housing.

16. A keyboard device for a portable electronic device according to claim 1, wherein said housing has an auxiliary storage that exchanges data with said portable electronic device.

17. A keyboard device for a portable electronic device according to claim 1, wherein said housing has a voice input mechanism.

18. A charging device for a portable electronic device comprising:
connecting mechanism to electrically connect a portable electronic device;
a power supply to one of drive and charge said portable electronic device; and
an input mechanism to operate said portable electronic device in a state in which said portable electronic device is connected,
wherein said connecting mechanism, said power supply, and said input mechanism are held together inside a housing.
